(19) United States
(12) Patent Application Publication
(10) Pub. No.: US 2015/0233754 A1
(43) Pub. Date: Aug. 20, 2015

(54) MULTIPLE ARM BALANCE SCALE

(71) Applicant: Stephen A. Pedneault, Glastonbury, CT (US)

(72) Inventor: Stephen A. Pedneault, Glastonbury, CT (US)

(21) Appl. No.: 14/626,414

(22) Filed: Feb. 19, 2015

Related U.S. Application Data
(60) Provisional application No. 61/941,705, filed on Feb. 19, 2014.

(51) Int. Cl. G01G 1/20; G01G 21/14

(52) U.S. Cl. CPC G01G 1/20; G01G 21/14

(57) ABSTRACT

The present invention is directed to a balance scale that includes a base defining a vertical central axis and an upright extending upward from the base along the central axis and defining a top. At least four equally configured arms extend symmetrically from a fulcrum at the top of the upright and a platform is suspended from each of the at least four equally configured arms by a set of equidistant links.

### CROSS-REFERENCE TO RELATED APPLICATION

This application claims the benefit of U.S. Provisional Patent Application Ser. No. 61/941,705 filed on Feb. 19, 2014, which is incorporated herein by reference in its entirety.

### FIELD OF THE INVENTION

The present invention is directed to a balance scale for measuring and balancing mass thereon and in particular to a pivoted horizontal lever of equal length arms wherein a weighing pan is suspended from each arm. More particularly, the present invention is directed to a balance scale having four or more equal length arms wherein a weighing pan is suspended from each arm.

### DESCRIPTION OF THE RELATED ART

A balance scale is a mass measuring instrument that typically comprises a pivoted horizontal lever forming two equal length arms, referred to as a beam, with a scale or a weighing pan suspended from each arm. An unknown mass is placed in one pan and standard weights having a known mass are added to the other pan until the beam balances or reaches a point of equilibrium.

A traditional balance scale exhibiting one beam or lever having two equal length arms extending symmetrically from a fulcrum, the support about which a lever pivots, is a traditional symbol of justice which corresponds to the use in metaphor of matters being “held in the balance.”

### SUMMARY OF THE INVENTION

The present invention is directed to a balance scale comprising a base defining a vertical central axis and an upright extending upward from the base along the central axis and defining a top. At least four equally configured arms extend symmetrically from a fulcrum at the top of the upright and a platform is suspended from each of the at least four equally configured arms by a set of equidistant links.

### BRIEF DESCRIPTION OF THE DRAWINGS

FIG. 1 depicts a balance scale having four equal length arms wherein a weighing pan is suspended from each arm in accordance with one embodiment of the present invention.

FIG. 2A is top view of a balance scale having four equal length arms wherein a weighing pan is suspended from each arm in accordance with another embodiment of the present invention.

FIG. 2B is a side view of the balance scale of FIG. 2A.

FIG. 3 depicts a balance scale having four equal length arms wherein a weighing pan is suspended from each arm in accordance with yet another embodiment of the present invention.

### DETAILED DESCRIPTION

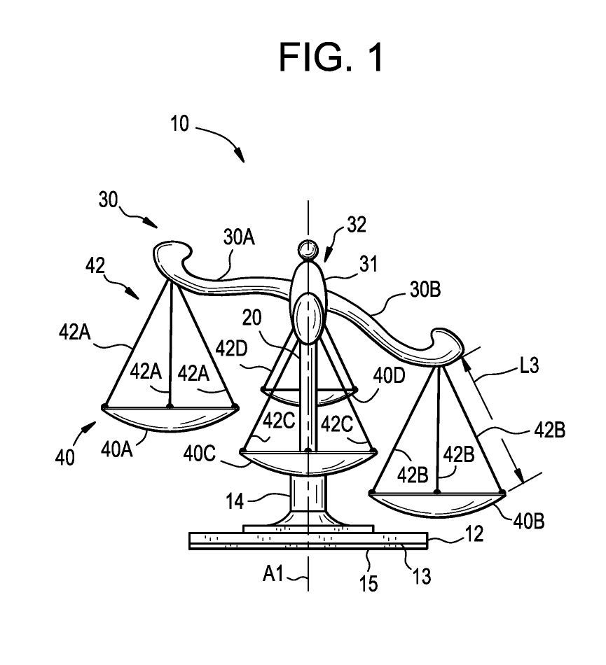

As shown in FIG. 1, a balance scale 10 includes a base 12 that defines a circular configuration having a vertical central axis “A1.” The base 12 also defines a bottom face 13. An upright 20 also defines a circular configuration and extends substantially vertically upward from the base 12 along the central axis A1 and defines an upright top 31. In one embodiment, the base 12 includes a mount 14 fixedly or securely attached to the base 12 or integrally formed therewith. The mount 14 also defines a circular configuration and extends substantially vertically upward from the base 12 along the central axis A1, and receives and securely engages therein the upright 20. While the base 12 is shown and described as defining a circular configuration, the present invention is not limited in this regard as the base 12 can define any configuration having a center of gravity from which the upright 20 can extend, such as for example, a triangle, a rectangle, or a polygon, without departing from the broader aspects of the invention. While the mount 14 and the upright 20 are shown and described as defining a circular configuration, the present invention is not limited in this regard as the mount 14 and the upright 20, individually or in combination, can define any configuration having a central axis along which the mount 14 and the upright 20 can extend substantially vertically upward from the base 12, such as for example, a triangle, a rectangle, or a polygon, without departing from the broader aspects of the invention.

The balance scale 10 includes a plurality of equally configured arms 30 extending symmetrically from a fulcrum 32. In the embodiment shown in FIG. 1, the balance scale 10 includes four equally configured arms 30A, 30B, 30C and 30D (only 30A and 30B are visible in FIG. 1). While the equally configured arms 30 are shown and described as including four equally configured arms 30A, 30B, 30C and 30D, the present invention is not limited in this regard as the equally configured arms 30 can include any number of equally configured arms in excess of four without departing from the broader aspects of the invention.

In one embodiment of the present invention, a platform 40 is suspended from each arm 30 via a set of equidistant links 42. In the embodiment shown in FIG. 1, a weighing pan 40A, 40B, 40C and 40D is suspended respectively from each of the arms 30A, 30B, 30C and 30D by a respective set of three equidistant links 42A, 42B, 42C and 42D (only two links 42C and 42D are visible in FIG. 1). Each of the respective sets of three equidistant links 42A, 42B, 42C and 42D define a length “L3.” While the platforms 40 are shown and described as being suspended from each arm 30 via a set of equidistant links 42, the present invention is not limited in this regard as the platforms 40 may be removeably or fixedly attached directly to and suspended from each arm 30, or integrally formed with each arm 30, without departing from the broader aspects of the invention. While the platforms 40 and more particularly each weighing pan 40A, 40B, 40C and 40D are shown and described as being suspended respectively from each of the arms 30A, 30B, 30C and 30D via a respective set of three equidistant links 42A, 42B, 42C and 42D, the present invention is not limited in this regard as the set of equidistant links 42 may include more or less than three equidistant links 42A, 42B, 42C and 42D, or two equidistant links may be formed by one continuous link that slideably engages one of the arms 30. While the platforms 40 are shown and described as being suspended from the arms 30 via a set of equidistant links 42, the present invention is not limited in this regard as the set of equidistant links 42 may be integrally formed with each arm 30 or each platform 40 without departing from the broader aspects of the invention. While the platforms 40 are shown and described as being suspended from the arms 30 via a set of equidistant links 42, the present invention is not limited in this regard as the set of equidistant links 42 may be integrally formed with each arm 30 or each platform 40 without departing from the broader aspects of the invention. While the platforms 40 are shown and described as including a weighing pan 40A, 40B, 40C and 40D suspended respectively from each of the arms 30A, 30B, 30C and 30D, the present invention is not limited in this regard as each of the platforms 40 may include a link or hook from which to releasable connect or hang an item or an item or a known mass therefrom without departing from the broader aspects of the invention.

The base 12, mount 14, upright 20, arms 30 and platforms 40 may be fabricated from any suitably rigid material such as wood, stone, metal, metal alloy, plastic, or other synthetic material or any combination thereof. In addition, each of the base 12, mount 14, upright 20, arms 30 and platforms 40 may be fabricated from the same material or from material different from one another, or any combination thereof. The set of equidistant links 42 may be formed from any suitably flexible material such as a cloth line, a plastic line such as for example nylon, a line of chain links wherein such chain links are fabricated from cloth, metal, plastic or other synthetic material.

In one embodiment, the bottom face 13 of the base 12 includes a substantially smooth liner 15 positioned thereon. The liner 15 may be fabricated from any suitably smooth or soft material such as cloth, rubber, plastic or other synthetic material. The liner 15 is fixedly attached to the bottom face 13 via an adhesive or the like.

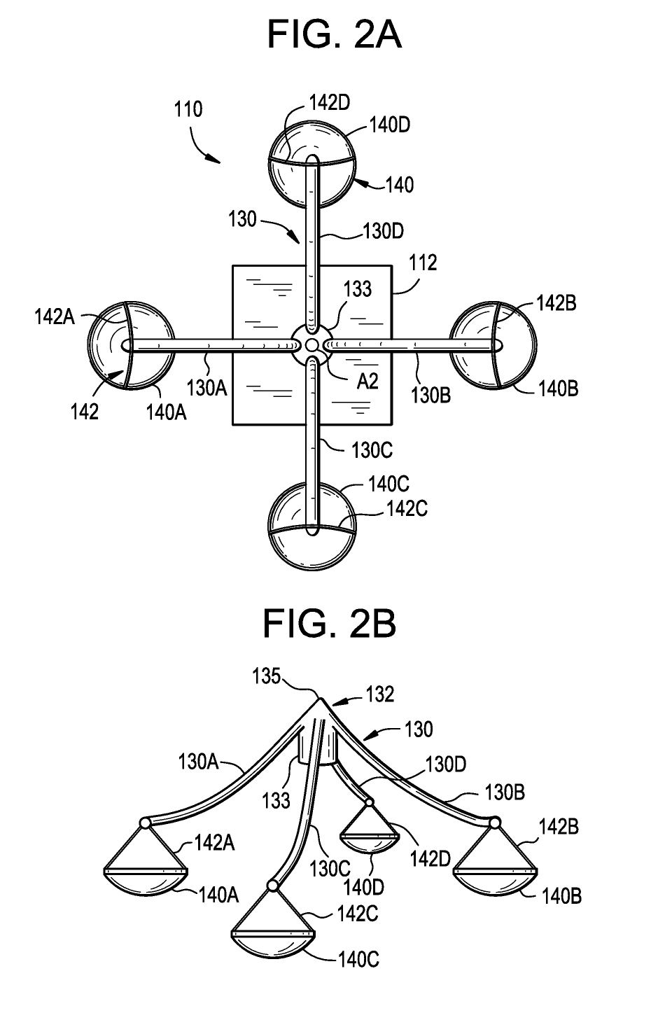

Another embodiment of a balance scale 110 is depicted in FIG. 2A and is similar to the balance scale 10 depicted in FIG. 1, thus like elements are given a like element number preceded by the numeral 1.

As shown in FIGS. 2A and 2B, the balance scale 110 includes a base 112 that defines a rectangular configuration having a vertical central axis “A2.” An upright (not shown) extends substantially vertically upward from the base 112 along the central axis A2. The balance scale 110 includes a plurality of equally configured arms 130 extending symmetrically from a fulcrum 132. In the embodiment shown in FIGS. 2A and 2B, the balance scale 110 includes four equally configured arms 130A, 130B, 130C and 130D. A platform 140 is suspended from each arm 130 via a set of equidistant links 142. In the embodiment shown in FIGS. 2A and 2B, a weighing pan 140A, 140B, 140C and 140D is suspended respectively from each of the arms 130A, 130B, 130C and 130D via a respective equidistant hanging element 142 including a hook or hanger 142A, 142B, 142C and 142D. The equally configured arms 130 are integrally formed with a fulcrum element 133 that is positioned over an upright (not shown) that extends substantially vertically upward from the base 112 along the central axis A2. The equally configured arms 130 pivot about a fulcrum point 135 defined by the fulcrum element 133.

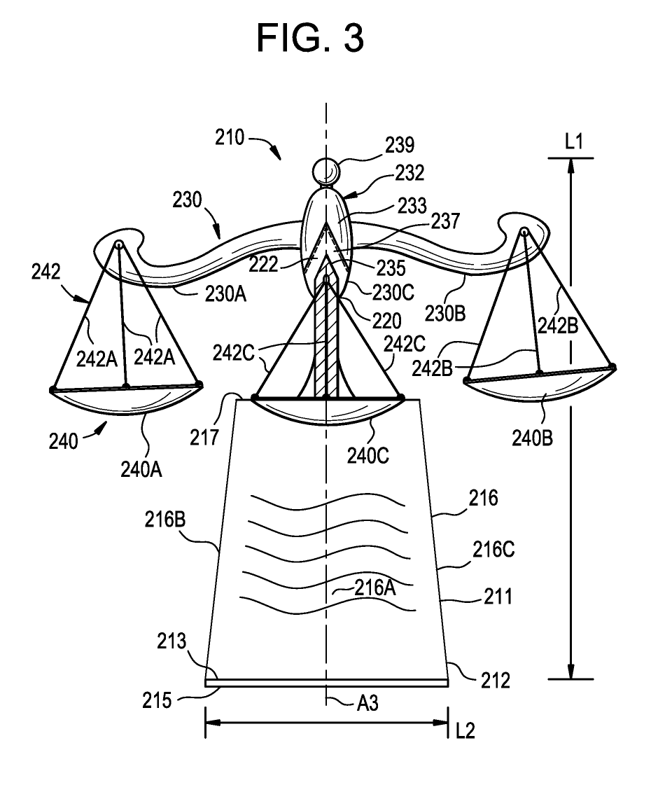

Another embodiment of a balance scale 210 is depicted in FIG. 3 and is similar to the balance scales 10 and 110 respectively depicted in FIGS. 1 and FIG. 2A, thus like elements are given a like element number preceded by the numeral 2.

As shown in FIG. 3, the balance scale 210 includes a base 212 that defines a rectangular stanchion 211 having a vertical central axis “A3.” The base 212 also defines a bottom face 213. The stanchion 211 defines an outside surface 216 having a front face 216A, a first side face 216B, a second side face 216C, and a back face (not shown). An upright 220 defines a circular configuration and extends substantially vertically upward from the base 212 along the central axis A3. While the base 212 is shown and described as defining rectangular stanchion 211, the present invention is not limited in this regard as the base 212 can define any block-type support or pedestal having a center of gravity from which the upright 220 can extend, such as for example, a circular or multi-sided pillar or a column or the like, without departing from the broader aspects of the invention.

The balance scale 210 includes a plurality of equally configured arms 230 extending symmetrically from a fulcrum 232. In the embodiment shown in FIG. 3, the balance scale 210 includes four equally configured arms 230A, 230B and 230C, and 230D (not shown). A platform 240 is suspended from each arm 230 via a set of equidistant links 242. In the embodiment shown in FIG. 3, a weighing pan 240A, 240B and 240C, and 240D (not shown) is suspended respectively from each of the arms 230A, 230B, 230C and 230D via a respective equidistant hanging element 242 including a hook or hanger 242A, 242B and 242C, and 242D (not shown). The equally configured arms 230 are integrally formed with a fulcrum element 233 having an interior cavity 237 configured to receive a correspondingly configured upright termination 222 such that the equally configured arms 230 pivot about a fulcrum point 235 defined by the upright termination 222. In one embodiment, the bottom face 213 of the base 212 is lined with a substantially smooth liner 215. In one embodiment, the fulcrum element 233 defines a fulcrum element top 239.

In one embodiment, the top 239 is inscribed or otherwise displays an ornate emblem, insignia, crest, symbol, text or the like. In one embodiment, at least a portion of the outside surface 216 of the stanchion 211 is inscribed or otherwise displays an ornate emblem, insignia, crest, symbol, text or the like. In one embodiment, such text includes an inspirational message.

One embodiment of the balance scale 210 defines a height “L1” and the bottom face 213 of the base 212 defines a rectangle having a side length “L2.” In one embodiment, L1 and L2 are sized such that the balance scale 210 may be placed on a desk, wherein L1 is in the range of up to about (12) inches, and more particularly in the range of about six (6) inches to about twelve (12) inches; and L2 is in the range of up to about six (6) inches, and more particularly in the range of about two (2) inches to about four (4) inches. While the side length L2 is shown and described as being a length of the side of a rectangle, the present invention is not limited in this regard as L2 represents the longest length across the bottom face 213 of the base 212, such as for example an outer diameter, without departing from the broader aspects of the invention. Such an embodiment of the balance scale 210 corresponds to the use in metaphor of matters of life that must be held in the balance wherein such matters include four or more elements or aspects of life.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A balance scale comprising:
a base defining a vertical central axis;
an upright extending upward from the base along the central axis and defining a top;
at least four equally configured arms extending symmetrically from a fulcrum at the top of the upright; and
a platform suspended from each of the at least four equally configured arms by at least two equidistant links.

2. The balance scale of claim 1 wherein each of the platforms comprises a weighing pan.

3. The balance scale of claim 1 having more than four equally configured arms extending symmetrically from the fulcrum at the top of the upright.

4. The balance scale of claim 1 wherein the at least four equally configured arms are integrally formed with the fulcrum at the top of the upright.

5. The balance scale of claim 1 wherein the platform is suspended from each of the at least four equally configured arms by more than two equidistant links.

6. The balance scale of claim 1 wherein the base further comprises a bottom face and a liner positioned thereon.

7. The balance scale of claim 1 wherein the base comprises a stanchion.

8. The balance scale of claim 1 wherein the balance scale defines a height L1 and a longest length L2 across a bottom face of the base, and wherein L1 is in the range of up to about (12) inches and L2 is in the range of up to about six (6) inches.

9. The balance scale of claim 8 wherein L1 is in the range of about six (6) inches to about twelve (12) inches, and L2 is in the range of about two (2) inches to about four (4) inches.
